(19) United States
(12) Patent Application Publication
(10) Pub. No.: US 2024/0330013 A1
(43) Pub. Date: Oct. 3, 2024

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Ryota KOMORI, Kanagawa (JP)

(73) Assignee: FUJIFILM Business Innovation Corp., Tokyo (JP)

(21) Appl. No.: 18/366,689

(22) Filed: Aug. 8, 2023

(30) Foreign Application Priority Data
Mar. 27, 2023 (JP) 2023-050202

(51) Int. Cl. G06F 9/445

(52) U.S. Cl. CPC G06F 9/44505

(57) ABSTRACT

An information processing system includes a processor configured to, if a second device different from a first device is installed in place of the first device that is originally scheduled to be installed, reflect a setting corresponding to the second device in a reference setting that is from among settings to be set in a third device originally scheduled to cooperate with the first device and is set by referencing the first device.

### CROSS-REFERENCE TO RELATED APPLICATIONS

This application is based on and claims priority under 35 USC 119 from Japanese Patent Application No. 2023-050202 filed Mar. 27, 2023.

### Background

### (i) Technical Field

The present disclosure relates to an information processing system, a non-transitory computer readable medium, and an information processing method.

### (ii) Related Art

Japanese Unexamined Patent Application Publication No. 2006-164025 discloses a multi-function apparatus. The multi-function apparatus includes a personalization unit that modifies a variety of settings of the multi-function apparatus, a memory that stores the variety of settings, and a unit that receives via a network a variety of setting information on the multi-function apparatus from a device on the network. The multi-function apparatus further includes an analyzing unit that analyzes setting contents of the variety of setting information on the multi-function apparatus received from the device on the network. The multi-function apparatus further includes a determiner that identifies information on a transmitting device information out of the variety of setting information on the multi-function apparatus received from the device on the network and determines whether the transmitting device belongs to the same group as the multi-function apparatus. The multi-function apparatus further includes a unit that changes the timing of validating the setting information on the multi-function apparatus depending on the contents of the setting information analyzed by the analyzing unit if the determiner determines that the transmitting device belongs to the same group as the multi-function apparatus.

There are times when a second device is installed in place of a first device though the first device is originally scheduled to be installed. In such a case, the first device is difficult to reference about a reference setting that is to be set by referencing the first device, among settings that are set in a third device scheduled to cooperate with the first device. A user may thus modify the setting to be set in the third device before the third device is installed.

### SUMMARY

Aspects of non-limiting embodiments of the present disclosure relate to providing an information processing system, a non-transitory computer readable medium, and an information processing method letting a user free from modifying the setting that is to be set in the third device before the third device scheduled to cooperate with the first device is installed even when the second device is installed in place of the first device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to, if a second device different from a first device is installed in place of a first device that is originally scheduled to be installed, reflect, in a reference setting that is from among settings to be set in a third device originally scheduled to cooperate with the first device and is set by referencing the first device, a setting of the second device corresponding to the reference setting.

### BRIEF DESCRIPTION OF THE DRAWINGS

Exemplary embodiments of the present disclosure will be described in detail based on the following figures, wherein:

FIG. 1 schematically illustrates an example of a hardware configuration of a service system according to exemplary embodiments;

FIG. 2 is a block diagram illustrating an example of a hardware configuration of a device according to the exemplary embodiments;

FIG. 3 is a block diagram illustrating an example of a hardware configuration of an information processing apparatus according to the exemplary embodiments;

FIG. 4 is a flowchart illustrating an example of a flow of an information processing process performed by the information processing apparatus of a first exemplary embodiment;

FIG. 5 schematically illustrates an example of a configuration of a device database according to the exemplary embodiments;

FIG. 6 schematically illustrates an example of a configuration of a setting database according to the exemplary embodiment; and

FIG. 7 is a flowchart illustrating an example of a flow of an information processing process of an information processing apparatus according to a second exemplary embodiment.

### DETAILED DESCRIPTION

### First Exemplary Embodiment

Exemplary embodiments of the disclosure are described below with reference to the drawings. In the drawings, identical or equivalent elements and portions are designated with the same reference numerals. The scales of the drawings may be exaggerated for convenience of explanation and may not necessarily be to scale.

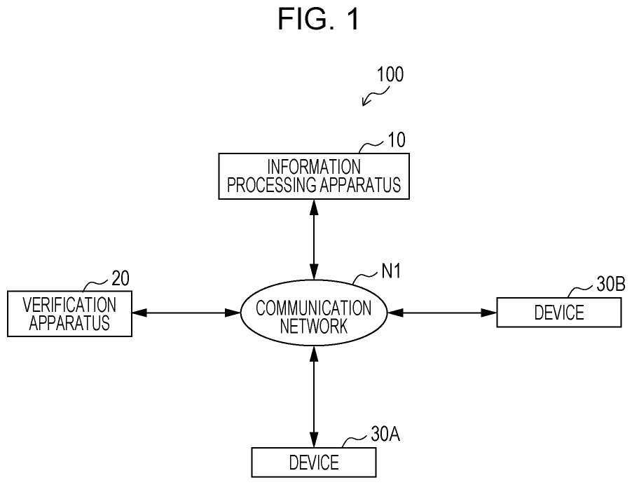

Referring to FIG. 1, an information processing system 100 of exemplary embodiments includes an information processing apparatus 10, verification apparatus 20, and multiple devices 30A, 30B. . . . The number of devices 30 are not limited to the number illustrated in FIG. 1. In the following discussion, the devices 30A and 30B, if not discriminated from each other, are simply referred to as devices 30.

The information processing apparatus 10, verification apparatus 20, and device 30 are communicable with each other via a communication network N. According to the exemplary embodiments, the communication network N is a publicly available communication network, such as the Internet or a telephone network. The communication network N is not limited to the Internet or telephone network. For example, the communication network N may be an in-house communication network, such as a local-area network (LAN) or wide-area network (WAN) or a combination of the in-house communication network and publicly available communication network. According to the exemplary embodiments, the communication network N is a radio communication network. The disclosure is not limited to this configuration. The communication network N may be a wired communication network or a combination of the radio communication network and wired communication network.

The verification apparatus 20 produces a setting for each device 30 and determines whether the device 30 loaded with the setting operates correctly. Specifically, the verification apparatus 20 uses the setting of the device 30 and model information on the device 30 to reproduce an environment where the device 30 is installed. The verification apparatus 20 applies the setting of the device 30, thereby verifying whether the information processing system 100 including the device 30 operates correctly. The verification apparatus 20 verifies the settings between the devices 30 establishing a reference relationship. Upon verifying that the device 30 operates correctly, the verification apparatus 20 transmits the setting of the device 30 to the information processing apparatus 10. According to the exemplary embodiments, the verification apparatus 20 is installed in a cloud environment. The disclosure is not limited to this configuration. The verification apparatus 20 may not necessarily be installed in the cloud environment.

The device 30 is an image forming apparatus that forms an image on a paper sheet serving as a recording medium. The disclosure is not limited to this configuration. The device 30 may be any device as long as the devices 30 are able to establish a reference relationship.

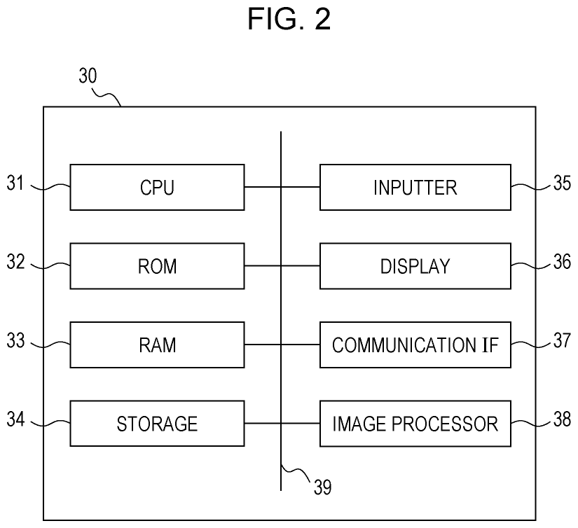

Referring to FIG. 2, the device 30 includes a central processing unit (CPU) 31, read-only memory (ROM) 32, random-access memory (RAM) 33, storage 34, inputter 35, display 36, communication interface (IF) 37, and image processor 38. These elements are communicable with each other via a bus 39. The device 30 includes an image reader that reads image data and an image former that forms an image on the paper sheet serving as the recording medium in response to the image data.

The CPU 31 is a central processing unit, executes a variety of programs and controls the elements. Specifically, the CPU 31 reads a program from the ROM 32 or storage 34 and executes the program using the RAM 33 as a work area. In accordance with the program stored on the ROM 32 or storage 34, the CPU 31 controls the elements and performs a variety of arithmetic operations.

The ROM 32 stores a variety of programs and a variety of data. The RAM 33 operates as a work area, thereby storing the programs and data. The storage 34 includes a hard-disk drive (HDD) or solid-state drive (SSD) and stores a variety of programs including an operating system and a variety of data.

The inputter 35 includes a pointing device, such as a mouse, and a keyboard and is used to enter a variety of inputs. The display 36 is, for example, a liquid-crystal display and displays a variety of information. The display 36 may be a touch panel and may also operate as the inputter 35.

The communication IF 37 is used to communicate with other devices, such as the devices 30, information processing apparatus 10, and verification apparatus 20. The communication IF 37 may comply with standards, such as Ethernet (registered trademark), FDDI, or Wi-Fi (registered trademark).

The image processor 38 performs image processing.

The information processing apparatus 10 is an example of an information processing system. According to the embodiments, the term “system” refers to a configuration including multiple apparatus or a single apparatus.

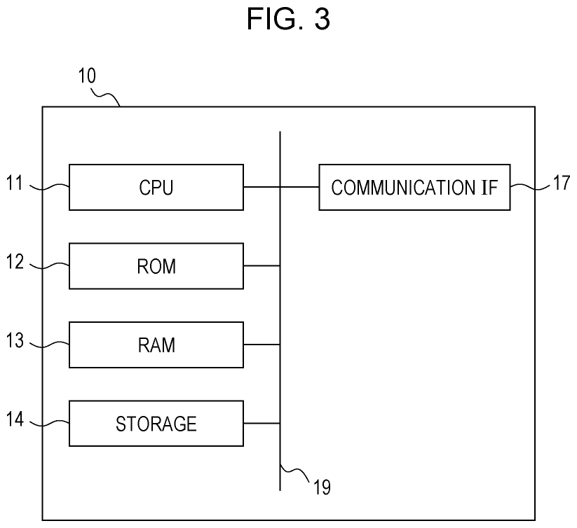

Referring to FIG. 3, the information processing apparatus 10 includes the CPU 11, ROM 12, RAM 13, storage 14, and communication IF 17. These elements are communicably interconnected to each other via a bus 19.

The CPU 11 is a central processing unit, executes a variety of programs and controls the elements. Specifically, the CPU 11 reads a program from the ROM 12 or storage 14 and executes the program using the RAM 13 as a work area. In accordance with the program stored on the ROM 12 or storage 14, the CPU 11 controls the elements and performs a variety of arithmetic operations. According to the exemplary embodiments, the ROM 12 or storage 14 stores an information processing program, device database, and setting database.

The ROM 12 stores a variety of programs and a variety of data. The RAM 13 operates as a work area, thereby storing the programs and data. The storage 14 includes a HDD or SSD and stores a variety of programs including an operating system, a variety of data, device database, and setting database.

The communication IF 17 is used to communicate with other devices, such as the devices 30, and verification apparatus 20. The communication IF 37 may comply with the standards, such as Ethernet (registered trademark), FDDI, or Wi-Fi (registered trademark).

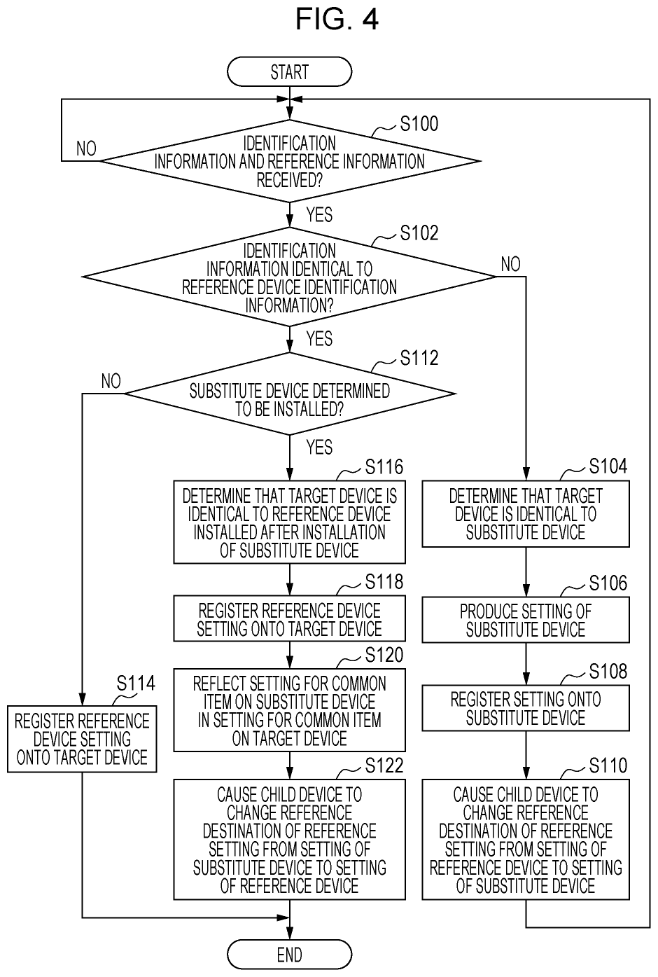

Referring to FIG. 4, the flow of the information processing process of the information processing apparatus 10 of the exemplary embodiments is described below. The CPU 11 performs the information processing process by reading an information processing program from the storage 14 and by loading the information processing program onto the RAM 13.

In step S100 in FIG. 4, the CPU 11 waits on standby until identification information identifying the device 30 and reference information indicating that the device 30 is a reference device have been received. The identification information is an Internet protocol (IP) address or a serial number of the device 30. When the identification information and reference information are received from the device 30 (yes path in step S100), the CPU 11 proceeds to step S102. In the following discussion, the device 30 related to the identification information and reference information received by the CPU 11 in step S100 is referred to as a target device.

In step S102, the CPU 11 determines whether the identification information received in step S100 matches reference device identification information identifying a reference device in the device database. Specifically, the CPU 11 determines whether the identification information related to the reference information in the device database matches the identification information received in step S100. If the received identification information does not match the reference device identification information (no path in step S102), the CPU 11 proceeds to step S104.

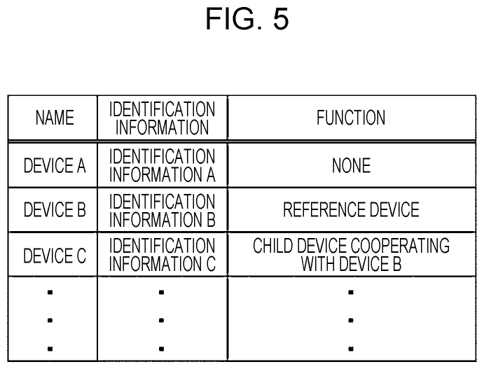

FIG. 5 illustrates an example of a structure of the device database. Referring to FIG. 5. the device database associates the name of each device 30, identification information identifying each device 30, and function of each device 30. Referring to FIG. 5, the identification information on a device A is identification information A and no function is assigned to the device A. The identification information on a device B is identification information B and the function of the device B is a reference device. The identification information on a device Cis identification information C and the function of the device C is a child device that cooperates with the device B. The reference device is an example of a first device and the child device is an example of a third device.

In step S104, the CPU 11 determines that the target device is a substitute device that is different from the reference device and has been installed in place of the reference device that is originally scheduled to be installed. The substitute device is an example of a second device.

In step S106, the CPU 11 produces the setting of the substitute device (in other words, the target device). Specifically, the CPU 11 reads a reference device setting pre-produced for the reference device by referring to the setting database. The CPU 11 acquires an item set for the target device. The CPU 11 uses a setting set for a common item in the reference device setting as a setting for an item common to the reference device and the substitute device. The CPU 11 uses a predetermined setting as a setting that is different from the reference device to the substitute device.

According to the first exemplary embodiment, the predetermined setting is a setting received from a user of the substitute device. The disclosure is not limited to this method. For example, the predetermined setting may be a setting that is determined in accordance with a contract status of the substitute device. In such a case, the predetermined setting may be a setting that is available to the user free of charge or a setting that is available to the user at the lowest cost.

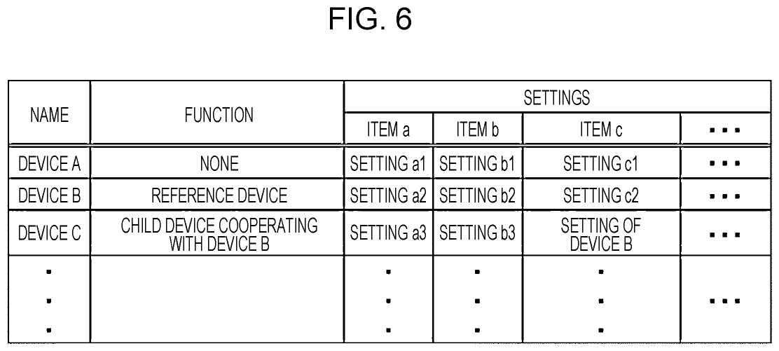

FIG. 6 illustrates an example of a structure of the setting database. The setting database stores the setting of each device 30 pre-produced by the verification apparatus 20. Specifically, as illustrated in FIG. 6, the setting database lists the name of each device 30, function of each device 30, and setting pre-produced for each device 30 in association with each other. Referring to FIG. 6, the device A with no function has setting a1 for item a, setting b1 for item b, and setting c1 for item c. The device B serving the reference device has setting a2 for item a, setting b2 for item b, and setting c2 for item c. The device C serving as the child device cooperating with the device B has setting a3 for item a, setting b3 for item b, and setting c3 for item c. Referring to FIG. 6, the settings respectively determined for items a, b, and c on the device B are reference device settings.

The setting database may store the setting on each device 30 pre-produced by the information processing apparatus 10 other than the verification apparatus 20 or by the user. In step S108, the CPU 11 registers the setting pre-produced in step S106 on the substitute device (the target device).

In step S110, the CPU 11 causes the child device scheduled to cooperate with the reference device to change a reference destination of a reference setting, which is among settings to be set in the child device and is set by referencing the reference device, from the setting of the reference device to the setting of the substitute device. In accordance with the change, the CPU 11 updates the setting database. The CPU 11 returns to step S100. Referring to FIG. 6, the CPU 11 updates the reference destination of the setting, which is among the settings to be set for the device C serving as the child device and is set for item c as a reference setting, from the setting of the device B to the setting of the substitute device.

Returning to step S102, if the received identification information matches the reference device identification information (yes path in step S102), the CPU 11 proceeds to step S112.

In step S112, the CPU 11 determines whether the substitute device has been determined to be installed. Specifically, the CPU 11 determines whether the operation in step S104 has been performed. If the substitute device has been determined to be installed (yes path in step S112), the CPU 11 proceeds to step S116. On the other hand, if the substitute device has not been determined to be installed (no path in step S112), the CPU 11 proceeds to step S114.

In step S114, the CPU 11 registers on the target device (the reference device) the reference device setting determined in the setting database. The information processing process thus ends.

In step S116, the CPU 11 determines that the target device is a reference device that is installed after the installation of the substitute device.

In step S118, the CPU 11 registers on the target device (in other words, the reference device installed after the installation of the substitute device) the reference device setting determined in the setting database.

In step S120, the CPU 11 reflects the setting set for a common item of the substitute device in the setting of the common item on the target device.

In step S122, the CPU 11 causes the child device to change the reference destination of the reference setting from the setting of the substitute device to the setting of the target device serving as the reference device. In accordance with the change, the CPU 11 updates the setting database. The information processing process thus ends.

### Second Exemplary Embodiment

According to the first exemplary embodiment, the CPU 11 reflects the setting of the substitute device corresponding to the reference setting in the reference setting by changing the reference destination of the reference setting from the setting of the reference device to the setting of the substitute device. According to a second exemplary embodiment, the CPU 11 reflects the corresponding setting of substitute device in the reference setting by reflecting the setting responsive to the reference setting of the substitute device in the child device.

If the reference device is installed after the installation of the substitute device, the CPU 11 reflects the setting set for the common item of the substitute device in the setting of the common item in the first exemplary embodiment after registering the reference device setting on the substitute device. According to the second exemplary embodiment, the CPU 11 registers the reference device setting in the reference device after reflecting the setting set for the common item of the substitute device in the reference device setting predetermined in the setting database.

Also, according to the first exemplary embodiment, if the reference device is installed after the installation of the substitute device, the CPU 11 reflects the setting of the reference device corresponding to the reference setting in the reference setting by changing the reference destination of the reference setting from the setting of the substitute device to the setting of the reference device. According to the second exemplary embodiment, the CPU 11 reflects the corresponding setting of the reference device in the reference setting by reflecting the setting responsive to the reference setting of the reference device in the child device.

The second exemplary embodiment is different from the first exemplary embodiment as described below. The second exemplary embodiment is identical in hardware configuration to the first exemplary embodiment and the discussion of the hardware configuration is not repeated herein.

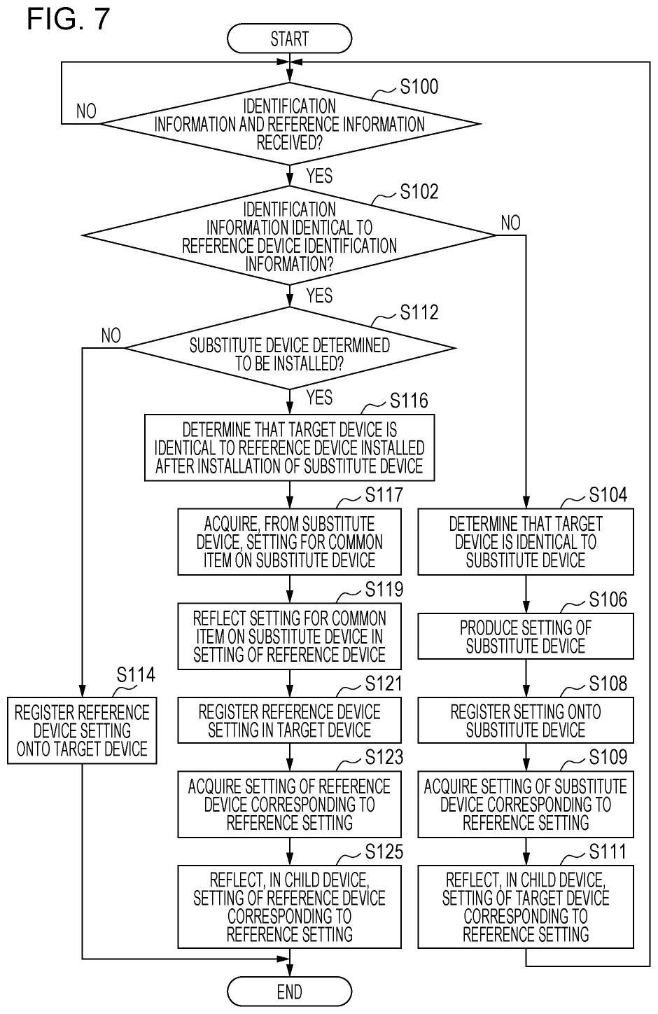

The flow of the information processing process of the information processing apparatus 10 of the second exemplary embodiment is described below with reference to FIG. 7.

The flow of the information processing process illustrated in FIG. 7 is different from the flow of the information processing process illustrated in FIG. 4 in that the operation in step S110 is replaced with operations in steps S109 and S111. Furthermore, the flow of the information processing process illustrated in FIG. 7 is different from the flow of the information processing process of the first exemplary embodiment illustrated in FIG. 4 in that the operations in steps S118, S120, and S122 are replaced with operations in steps S117, S119, S121, S123, and S125.

The flow of the information processing process illustrated in FIG. 7 is determined to be different from the flow of the information processing process of the first exemplary embodiment illustrated in FIG. 4 if at least one of the following points is satisfied, including one point that the operation in step S110 is replaced with the operations in steps S109 and S111, another point that the operations in steps S118 and S120 are replaced with steps S117, S119, and S121, or another point that the operation in step S122 is replaced with the operations in steps S123 and S125.

In step S109 in FIG. 7, the CPU 11 acquires the setting of the substitute device corresponding to the reference setting from the substitute device (in other words, the target device).

In step S111, the CPU 11 reflects in the child device the setting of the target device corresponding to the reference setting acquired in step S109. The CPU 11 then returns to step S100.

In step S117, the CPU 11 acquires from the substitute device the setting set for the common item of the substitute device.

In step S119, the CPU 11 reflects in the reference device setting determined in the setting database the setting set for the common item on the substitute device in step S117.

In step S121, the CPU 11 registers in the target device (in other words, the reference device installed after the installation of the reference device) the reference device setting reflecting the setting set for the common item on the substitute device in step S119.

In step S123, the CPU 11 acquires the setting of the reference device corresponding to the reference setting from the reference device (in other words, the target device) installed after the installation of the substitute device.

In step S125, the CPU 11 reflects in the child device the setting of the reference device corresponding to the reference setting acquired in step S123.

The exemplary embodiments are not intended to limit the disclosure defined by the claims and all the combinations of features described with reference to the exemplary embodiments may not necessarily be required to achieve the disclosure. The exemplary embodiments include a variety of phases of the disclosure and a variety of versions of the disclosure may be formed by a combination of disclosed elements. Even if a subset of the elements is deleted from the exemplary embodiments, a configuration without the subset may still form the disclosure as long as an effect is obtained.

According to the exemplary embodiments, the information processing apparatus 10 as a single apparatus performs the information processing process. The disclosure is not limited to this method. For example, multiple apparatuses may perform the information processing process.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

According to the exemplary embodiments, each program is installed onto the ROMs. The disclosure is not limited to this method. The program of each of the exemplary embodiments may be delivered in a recorded form on a computer readable recording medium. For example, the program of each of the exemplary embodiments may be delivered in a recorded form on a compact disc ROM (CD-ROM), a digital versatile disc ROM (DVD-ROM), an optical disc or a semiconductor memory, such as a universal serial bus (USB) or a memory card. The program of each of the exemplary embodiments may be acquired from an external apparatus via the communication IF 17.

According to the exemplary embodiments, the process of the information processing apparatus 10 is implemented by a software configuration when a computer executes the program. The disclosure is not limited to this method. For example, the process of the information processing apparatus 10 may be implemented by a hardware configuration or a combination the software configuration and the hardware configuration.

The information processing apparatus 10, verification apparatus 20, and device 30 have been described for exemplary purposes only and an element may be deleted therefrom or a new portion may be added thereto without departing from the scope of the disclosure.

The process of the information processing apparatus 10 described with reference to the exemplary embodiments has been described (see FIGS. 4 and 7) for exemplary purposes only and a step may be deleted from the process, a new step may be added to the process, or the order of operations of the process may be changed without departing from the scope of the disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system including:

a processor configured to, if a second device different from a first device is installed in place of the first device that is originally scheduled to be installed, reflect, in a reference setting that is from among settings to be set in a third device originally scheduled to cooperate with the first device and is set by referencing the first device, a setting of the second device corresponding to the reference setting.

(((2)))

In the information processing system according to (((1))), the processor is configured to reflect the setting of the second device corresponding to the reference setting in the reference setting by changing a reference destination of the reference setting from the setting of the first device to the setting of the second device.

(((3)))

In the information processing system according (((1))), the processor is configured to:

acquire from the second device the setting of the second device corresponding to the reference setting; and

reflect the setting of the second device corresponding to the reference setting in the reference setting by reflecting the setting responsive to the reference setting of the second device in the third device.

(((4)))

In the information processing system according to according to one of (((1))) through (((3))), the processor is configured to, after registering in the first device a setting pre-produced for the first device if the first device is installed after an installation of the second device, reflect a setting set for a common item of the second device in a setting for a common item to the first device and the second device.

(((5)))

In the information processing system according to according to one of (((1))) through (((3))), the processor is configured to:

if the first device is installed after an installation of the second device, acquire from the second device a setting set for a common item to the first device and the second device; and

after reflecting the setting set for the common item of the second device in a setting pre-produced for the first device, register the setting pre-produced for the first device in the first device.

(((6)))

In the information processing system according to according to one of (((4))) and (((5))), the processor is configured to, if the first device is installed after the installation of the second device, reflect a setting of the first device corresponding to the reference setting in the reference setting.

(((7)))

In the information processing system according to (((6))), the processor is configured to, if the first device is installed after the installation of the second device, reflect the setting of the first device corresponding to the reference setting in the reference setting by changing a reference destination of the reference setting from the setting of the second device to the setting of the first device.

(((8)))

In the information processing system according to (((6))), the processor is configured to: if the first device is installed after the installation of the second device, acquire from the first device the setting of the first device corresponding to the reference setting; and reflect the setting of the first device corresponding to the reference setting in the reference setting by reflecting the setting responsive to the reference setting of the first device in the third device.

(((9)))

A program causing a computer to execute a process for processing information, the process including:

if a second device different from a first device is installed in place of the first device that is originally scheduled to be installed, reflecting, in a reference setting that is from among settings to be set in a third device originally scheduled to cooperate with the first device and is set by referencing the first device, a setting of the second device corresponding to the reference setting.

What is claimed is:

1. An information processing system comprising:
a processor configured to, if a second device different from a first device is installed in place of the first device that is originally scheduled to be installed, reflect, in a reference setting that is from among settings to be set in a third device originally scheduled to cooperate with the first device and is set by referencing the first device, a setting of the second device corresponding to the reference setting.

2. The information processing system according to claim 1, wherein the processor is configured to reflect, in the reference setting, the setting of the second device corresponding to the reference setting by changing a reference destination of the reference setting from the setting of the first device to the setting of the second device.

3. The information processing system according to claim 1, wherein the processor is configured to:
acquire from the second device the setting of the second device corresponding to the reference setting; and
reflect, in the reference setting, the setting of the second device corresponding to the reference setting by reflecting, in the third device, the setting of the second device corresponding to the reference setting.

4. The information processing system according to claim 1, wherein the processor is configured to, after registering in the first device a setting pre-produced for the first device if the first device is installed after an installation of the second device, reflect a setting set for a common item of the second device in a setting for a common item to the first device and the second device.

5. The information processing system according to claim 1, wherein the processor is configured to:
if the first device is installed after an installation of the second device, acquire from the second device a setting set for a common item to the first device and the second device; and
after reflecting the setting set for the common item of the second device in a setting pre-produced for the first device, register the setting pre-produced for the first device in the first device.

6. The information processing system according to claim 4, wherein the processor is configured to, if the first device is installed after the installation of the second device, reflect, in the reference setting, a setting of the first device corresponding to the reference setting.

7. The information processing system according to claim 5, wherein the processor is configured to, if the first device is installed after the installation of the second device, reflect, in the reference setting, a setting of the first device corresponding to the reference setting.

8. The information processing system according to claim 6, wherein the processor is configured to, if the first device is installed after the installation of the second device, reflect, in the reference setting, the setting of the first device corresponding to the reference setting by changing a reference destination of the reference setting from the setting of the second device to the setting of the first device.

9. The information processing system according to claim 7, wherein the processor is configured to, if the first device is installed after the installation of the second device, reflect, in the reference setting, the setting of the first device corresponding to the reference setting by changing a reference destination of the reference setting from the setting of the second device to the setting of the first device.

10. The information processing system according to claim 6, wherein the processor is configured to:
if the first device is installed after the installation of the second device, acquire from the first device the setting of the first device corresponding to the reference setting; and
reflect, in the reference setting, the setting of the first device corresponding to the reference setting by reflecting, in the third device, the setting of the first device corresponding to the reference setting.

11. The information processing system according to claim 7, wherein the processor is configured to:
if the first device is installed after the installation of the second device, acquire from the first device the setting of the first device corresponding to the reference setting; and
reflect, in the reference setting, the setting of the first device corresponding to the reference setting by reflecting, in the third device, the setting of the first device corresponding to the reference setting.

12. A non-transitory computer readable medium storing a program causing a computer to execute a process for processing information, the process comprising:
if a second device different from a first device is installed in place of the first device that is originally scheduled to be installed, reflecting, in a reference setting that is from among settings set in a third device originally scheduled to cooperate with the first device and is set by referencing the first device, a setting of the second device corresponding to the reference setting.

13. An information processing method comprising:
if a second device different from a first device is installed in place of the first device that is originally scheduled to be installed, reflecting, in a reference setting that is from among settings set in a third device originally scheduled to cooperate with the first device and is set by referencing the first device, a setting of the second device corresponding to the reference setting.
